(19) United States
(12) Patent Application Publication
(10) Pub. No.: US 2007/0156418 A1
(43) Pub. Date: Jul. 5, 2007

(54) System and method to model business processes from a template

(76) Inventors: Matthias Richter, Sinsheim (DE); Gisella Dominquez Anzuinelli, Heidelberg (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/321,486

(22) Filed: Dec. 29, 2005

(51) Int. Cl. G06Q 99/00

(52) U.S. Cl. 705/1

(57) ABSTRACT

In an embodiment, a system and method models a business process object. The system and method provides a business object template having a plurality of data nodes, actions, and queries. One or more business process objects are instantiated from the business object template. The one or more business objects are associated with one or more master data objects. The one or more business process objects are then enabled to require an approval before changing a value of a data node in the one or more master data objects. The approval is a standardized approval process resulting from the instantiation of the business process object from the business object template.

### BACKGROUND

Corporations and other business entities many a times use software-based business processes to manage their operations. For example, a business typically sells one or more products, and then generates invoices for those sales. As another example, a business more than likely keeps track of its employees through an employee management system. These invoice or employee systems typically make use of a structured database that was created along with the system and which has set fields and data types. Consequently, if another department or division of the business unit would like to use a different structured invoice, that division has to either do without their particular needs, or a new database must be created with the new data types and data fields, and compiled into the system. Similarly, if an employee or personnel management system requires a new process or object, that new process or object must make use of the present database structure, or go through the trouble of having programmers create a new database for the system. Moreover, when new databases are created for such a system, many a time the programmer fails to use identical data types, data lengths, and data identifiers to describe the same data that will appear in the two different databases. This leads to the undesirable situation of a lack of consistency throughout the system. Additionally, if the invoice, personnel, or other business management system is created and maintained by a third party software vendor, that vendor has to have a programmer create new database systems for each customer to suit the customer's particular business needs. The art is therefore in need of a different software management system for businesses.

### SUMMARY

In an embodiment, a system and method models a business process object. The system and method provides a business object template having a plurality of data nodes, actions, and queries. One or more business process objects are instantiated from the business object template. The one or more business objects are associated with one or more master data objects. The one or more business process objects are then enabled to require an approval before changing a value of a data node in the one or more master data objects. The approval is a standardized approval process resulting from the instantiation of the business process object from the business object template.

### BRIEF DESCRIPTION OF THE DRAWINGS

FIG. 1 illustrates an example embodiment of a system to create and maintain a business management system.

FIG. 2 illustrates an example embodiment of the system of FIG. 1 applied to a system for the creation and maintenance of a personnel change management system.

FIGS. 3A, 3B, and 3C illustrate an example embodiment of a business object template for the personnel change management system of FIG. 2.

FIG. 4 illustrates an example embodiment of a process to instantiate business process objects.

FIG. 5 illustrates an example embodiment of a computer system upon which one or more embodiments of the invention may execute.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

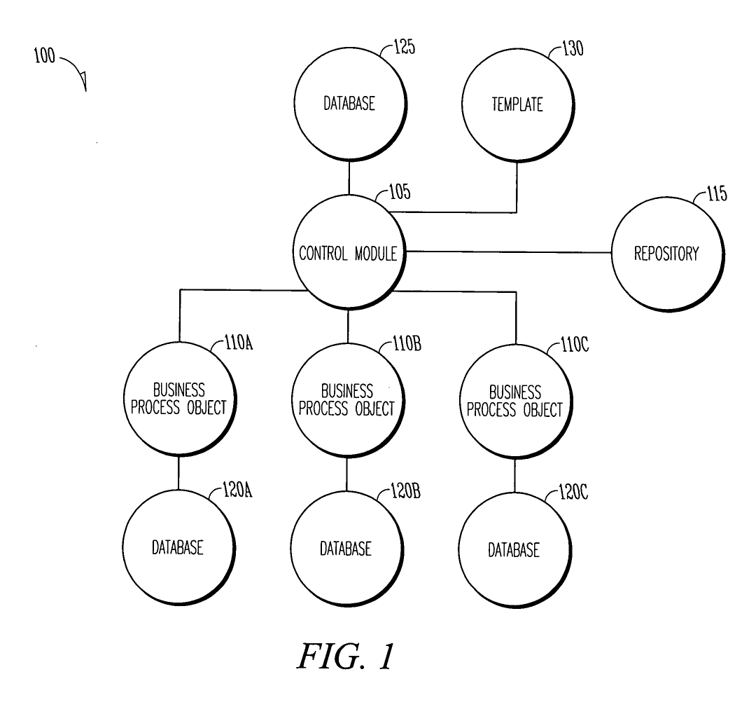

FIG. 1 illustrates a business system 100. The system 100 includes a control module 105 and business process objects 110A, 110B, and 110C. In an embodiment, the control module 105 includes a user interface or repository 115. The business process objects 110A, 110B, and 110C each include a database 120A, 120B, and 120C respectively. In another embodiment, these databases may be combined into a single database. The control module 105 is further coupled to a second database 125. The system 100 further includes a template 130. In an embodiment, the template 130 includes predefined data nodes, actions, and queries. A data node may include particular data types, and associated with these data types may be standardized definitions for each field in a data node including data field length, data field name, field description, and so on. An action may allow one or more tasks to be executed in the system 100, and a query may allow a party to examine the content of databases 120A, 120B, and 120C.

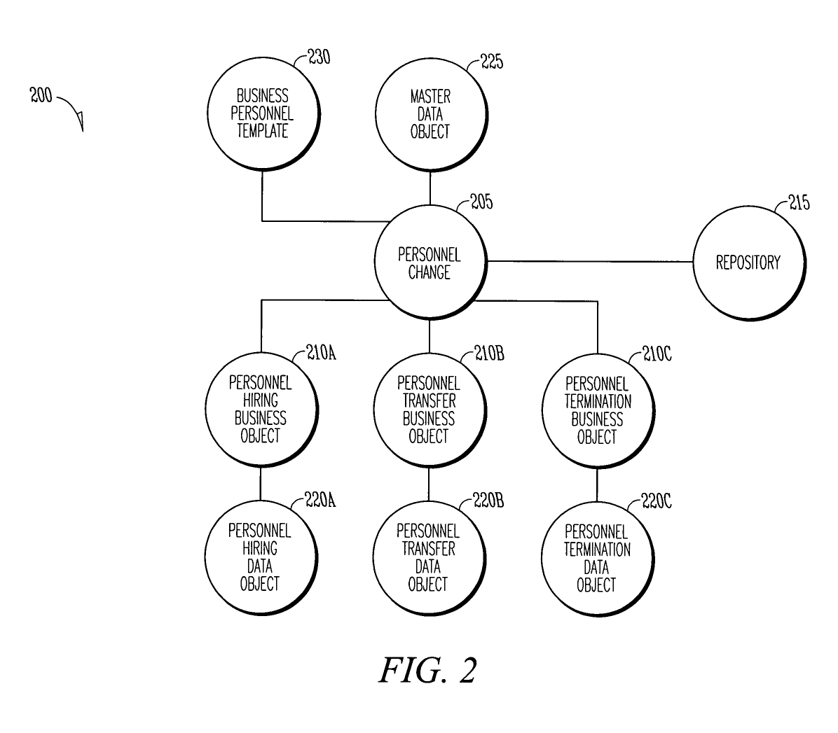

FIG. 2 illustrates one particular example of the business system 100 of FIG. 1 as applied to a business system that handles personnel information, and in particular, the creation, maintenance and changing of that personnel information. Specifically, FIG. 2 illustrates a system 200 that includes a Personnel Change module 205, and a Personnel Hiring business object 210A, a Personnel Transfer business object 210B, and a Personnel Termination object 210C. The Personnel Change module 205 may include a user interface or repository 215. The Personnel Hiring business object 210A is coupled to a Personnel Hiring data object 220A, the Personnel Transfer module 210B is coupled to a Personnel Transfer data object 220B, and the Personnel Termination module 210C is coupled to a Personnel-Termination data object 220C. In another embodiment, the business objects 210A, 210B, and 210C may share a single data object. As is further illustrated in FIG. 2, the Personnel Change module 205 is coupled to one or more Master data objects 225. The Personnel Change module 205 further has access to a Business Personnel change template 230. In another embodiment, the personnel change 205 is part of the business personnel template 230.

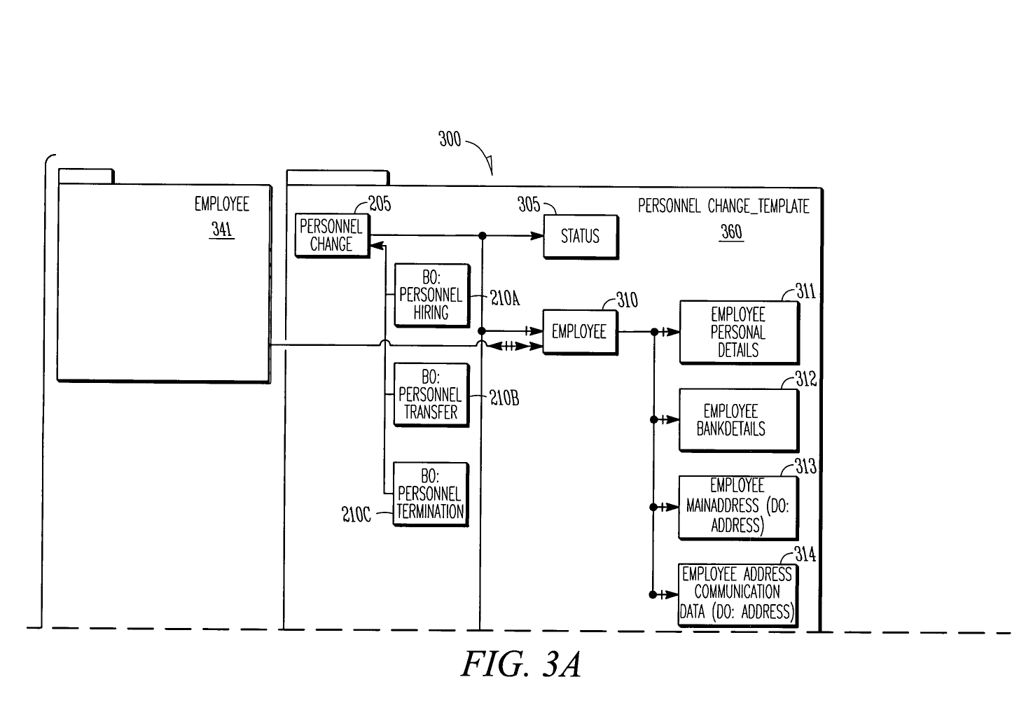

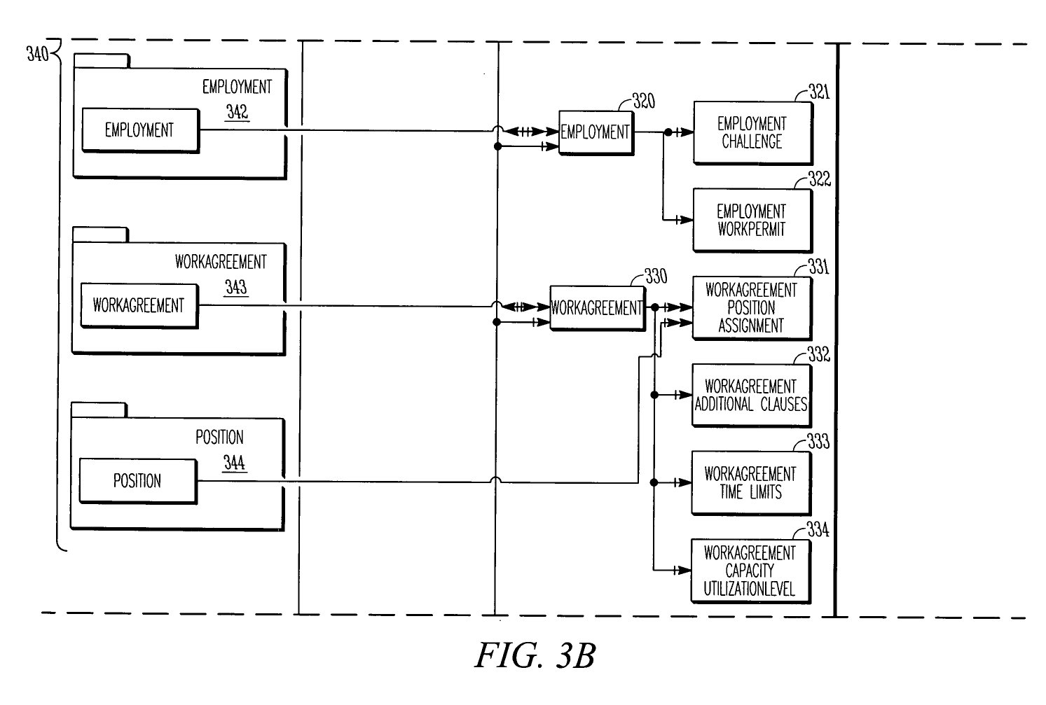

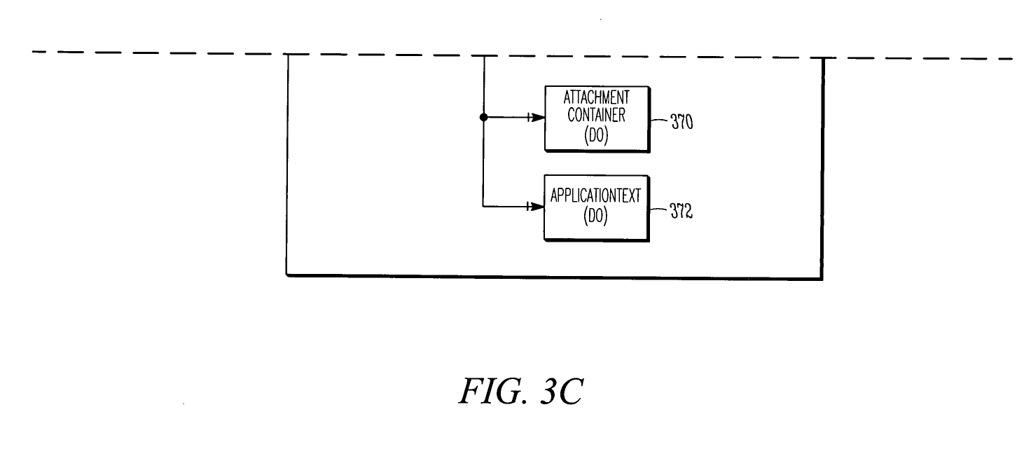

FIGS. 3A, 3B, and 3C illustrate an example embodiment of a template 300 that may be used in connection with personnel system 200 of FIG. 2. FIG. 3 illustrates master data objects 340 and a personnel change template 360. The personnel change template 360 includes an employee node 310, an employment node 320, a work agreement node 330, an attachment container 370, and an application text 372. An attachment container 370 is a grouping of all documents that are relevant for the business process object. For example, an attachment container may include employee photos, work permit certificates, disability certificates, and work agreements. The application text 372 is used to store unstructured text such as comments entered during the hiring process. In this embodiment, the employee node 310 includes data types of employee personal details 311, employee bank details 312, employee main address 313, and an employee data communication address 314. The employment node 320 includes data types of employment challenge 321 and employment work permit 322. The employment challenge 321 is used to indicate any disability issues for an employee, and the employment work permit 322 is used to record the work permits that are associated with a particular employee. The work agreement node 330 includes data types of a work agreement position assignment 331, a work agreement additional clauses 332, work agreement time limits 333, and work agreement capacity utilization level 334. In this embodiment, the work agreement position assignment 331 notes the employment positions of the employee, the work agreement additional clauses 332 notes any additional clauses of the work agreement that pertain to an employee, the work agreement time limits 333 notes the time periods which are relevant for the employment such as the duration of the probationary period, and the work agreement capacity utilization level 334 notes the percentage of an employee's working time as compared to a full time position. The status node 305 holds status information about the lifecycle of any personnel changes and the results and prerequisites of the processing steps.

FIGS. 3A, 3B, and 3C further illustrate that the nodes of the personnel change template 360 provide the data structure for the master data objects 340 and the personnel data objects 210A, 210B, and 210C. In particular, in this embodiment, the business process object includes references to an employee master data object 341, employment master data object 342, work agreement master data object 343, and position master data objects 344. As illustrated in FIGS. 3A, 3B, and 3C, the employee master data object 341 is logically coupled to the employee node 310 of the template 360, the employment master data object 342 is logically coupled to the employment node 320 of the template, the work agreement master data object 343 is logically coupled to the work agreement node 330 of the template, and the position master data object 344 is logically coupled to the work agreement position assignment 331. The personnel change template 360 further includes the Personnel Hiring business object 210A, the Personnel Transfer business object 210B, and the Personnel Termination object 210C. The business objects 210A, 210B, and 210C are imbued with one or more of the data types of the template 360 when a business process object is instantiated.

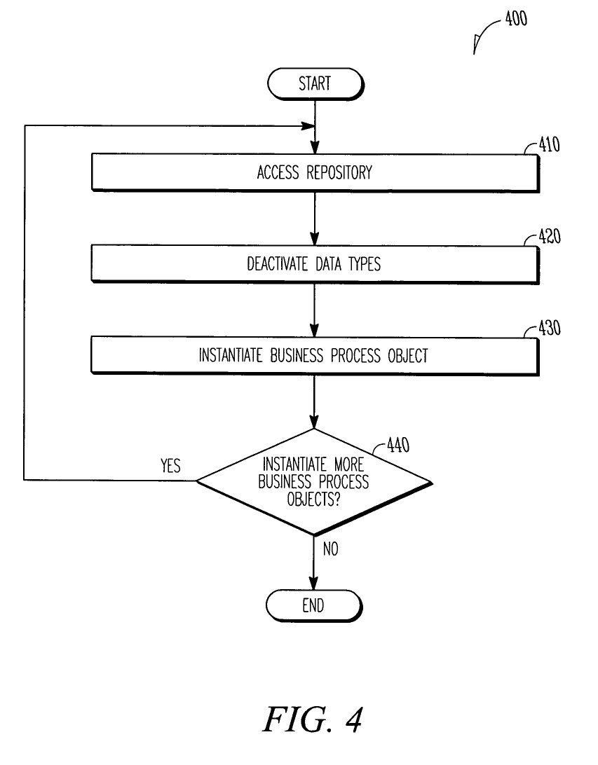

FIG. 4 illustrates a flowchart of an example embodiment of a process 400 that uses the template 300 of FIG. 3 to create a personnel change management system. The user interface or repository 215 is used to create one or more business process objects at operation 410. In an embodiment, the repository 215 presents a list of all the nodes and data types in the template 300, and the user deactivates the data types that are not desired for a particular business process object at operation 420. In another embodiment, the repository 215 is set up to require the user to select (e.g., by checking off) the data types, actions, and queries that are desired for a particular business process object. After deactivating the proper data types, actions, and queries at operation 420, a business process object is instantiated at operation 430. At operation 440, it is decided whether more business process objects are to be instantiated, in which case the process 400 returns to operation 410, or whether no more business process objects need to be created, in which case the process 400 terminates. Consequently, by using the repository 215, a plurality of business process objects may be instantiated, and the data types within each of those business process objects will be consistent in their definitions of the data types because all of the process objects were instantiated with the template 300. In the same manner, the actions and queries on these objects will have analogous behavior. For example, in an embodiment, and as illustrated in FIG. 2, a Personnel Hiring business process object 210A may be instantiated, a Personnel Transfer business process object 210B may be instantiated, and a Personnel Termination business process object 210C may be instantiated. These processes may then be invoked whenever an employee is hired, an employee is transferred, and an employee is terminated respectively.

After a system is created and business processes are instantiated, the system may be used to manage the personnel of a business organization. Thereafter, if a new business process object is to be added, it may be added by a non-programmer customer of the system, through the repository 215 and personnel change module 205, without programmer or systems personnel intervention. For example, if a new business process object is to be added to handle changing an employee's main address, a user would access the repository 215 and the template 360, indicate the desired fields for the change of address, such as employee main address 313, and create the change address business process object.

Additionally, upon instantiation of the business process objects, the business process objects may include a standardized approval process. The approval process includes a set of rules or steps that data is subjected to before that data is written to a master data object. The standardized approval process protects the master data objects from corruption, and allows the personnel data objects 220A, 220B, and 220C to be error tolerant during the process of making personnel changes. In at least one embodiment, the standardized approval process is a simple one step process, wherein the person who enters the data to approve the personnel change by himself or herself, thereby resulting in the data being written to the master data object. In yet another embodiment, a business process object may be enabled at the time of instantiation to collect the changed values during the approval process.

While one embodiment of the invention has been described in connection with a business process that creates a personnel change system, it should be noted that the invention is not limited to this embodiment, and that the invention is applicable to virtually any business process. For example, an order system could be created using a template such as the one in FIG. 3. The template for such an order system however would have data types such as product name, product description, product code, product price, quantity ordered, and other relevant data types. Then, using the order template, different business process objects may be created for the order system. Such a system has the same advantages as the advantages associated with the personnel change system as indicated above.

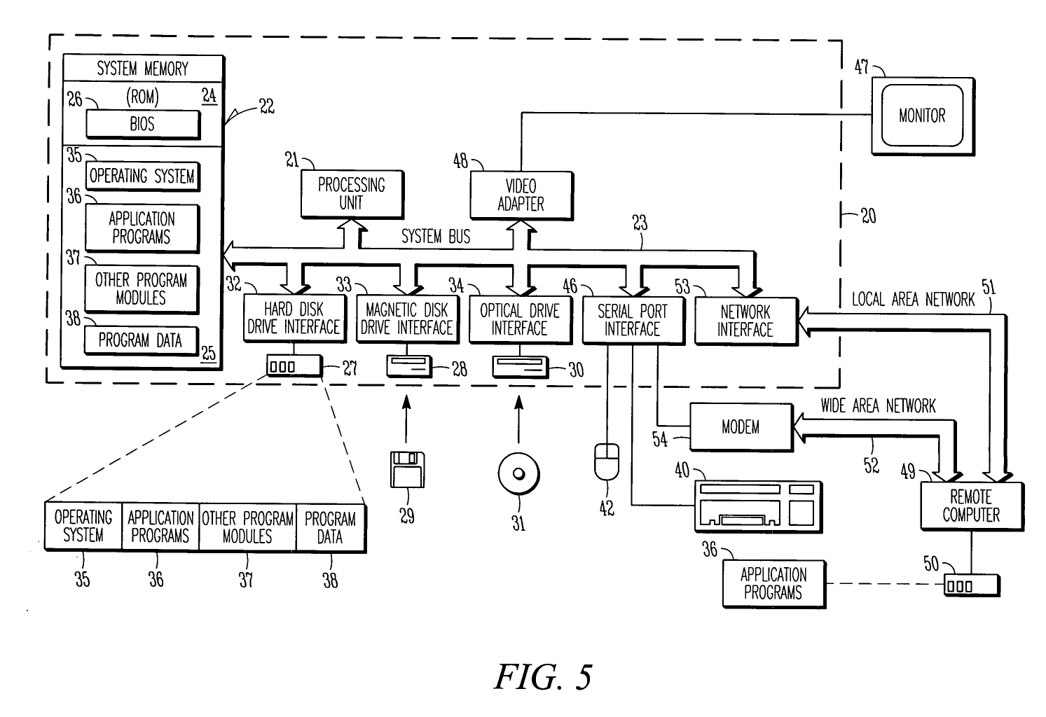

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A process comprising:
modeling one or more business process objects by:
providing a business object template including a plurality of data nodes, actions, and queries;
instantiating one or more business process objects from the business object template;
providing one or more master data objects associated with the one or more business process objects; and
enabling the one or more business process objects to require an approval before changing a value of a data node in the one or more master data objects, wherein the approval is a standardized approval process resulting from the instantiation of the business process object from the business object template.

2. The process of claim 1, wherein one or more of the business process objects includes a subset of the plurality of data nodes, actions, and queries; and wherein one or more of the data nodes in the business object template includes a definition that is reusable by the one or more business process objects.
A data node may include particular data types, and associated with these data types may be standardized definitions for each field in a data node including data field length, data field name, field description, and so on.

3. The process of claim 1, wherein the one or more business process objects relate to the one or more master data objects within a personnel administration context.

4. The process of claim 3, wherein the one or more business process objects relating to personnel administration further relate to one or more of an employee master data object, an employment master data object, a work agreement master data object, and a position master data object.

5. The process of claim 1, further comprising providing a user interface for use in connection with creating additional business process objects, the additional business process objects being created with the business object template.

6. The process of claim 1, wherein the business process objects relate to one or more of the hiring, transfer, and termination of an employee.

7. The process of claim 1, further comprising:
enabling the one or more business process objects to change the values of their respective data nodes without the standardized approval process; and
enabling the one or more business process objects to collect the changed values of the data nodes.

8. A system comprising:
a modeling module to model one or more business process objects, wherein the modeling module comprises:
a module to provide a business object template including a plurality of data nodes, actions, and queries;
a module to instantiate one or more business process objects from the business object template;
a module to provide one or more master data objects associated with the one or more business process objects; and
a module to enable the one or more business process objects to require an approval before changing a value of a data node in the one or more master data objects, wherein the approval is a standardized approval process resulting from the instantiation of the business process object from the business object template.

9. The system of claim 8, wherein one or more of the business process objects includes a subset of the plurality of data nodes, actions, and queries; and wherein one or more of the data nodes in the business object template includes a definition that is reusable by the one or more business process objects.

10. The system of claim 8, wherein the one or more business process objects relate to the one or more master data objects within a personnel administration context.

11. The system of claim 10, wherein the one or more business process objects relating to personnel administration further relate to one or more of an employee master data object, an employment master data object, a work agreement master data object, and a position master data object.

12. The system of claim 8, further comprising a module to provide a user interface for use in connection with creating additional business process objects, the additional business process objects being created with the business object template.

13. The system of claim 8, wherein the business process objects relate to one or more of the hiring, transfer, and termination of an employee.

14. The system of claim 8, further comprising:
a module to enable the one or more business process objects to change the values of their respective data nodes without the standardized approval process; and
a module to enable the one or more business process objects to collect the changed values of the data nodes.

15. A machine readable medium having instructions for executing a process comprising:
modeling one or more business process objects by:
providing a business object template including a plurality of data nodes, actions, and queries;
instantiating one or more business process objects from the business object template;
providing one or more master data objects associated with the one or more business process objects; and
enabling the one or more business process objects to require an approval before changing a value of a data node in the one or more master data objects, wherein the approval is a standardized approval process resulting from the instantiation of the business process object from the business object template.

16. The machine readable medium of claim 15, wherein one or more of the business process objects includes a subset of the plurality of data nodes, actions, and queries; and wherein one or more of the data nodes in the business object template includes a definition that is reusable by the one or more business process objects.

17. The machine readable medium of claim 15, wherein the one or more business process objects relate to the one or more master data objects within a personnel administration context.

18. The machine readable medium of claim 17, wherein the one or more business process objects relating to personnel administration further relate to one or more of an employee master data object, an employment master data object, a work agreement master data object, and a position master data object; and further wherein the business process objects relate to the hiring, transfer, and termination of an employee.

19. The machine readable medium of claim 15, further comprising instructions for providing a user interface for use in connection with creating additional business process objects, the additional business process objects being created with the business object template.

20. The machine readable medium of claim 15, further comprising instructions for:
enabling the one or more business process objects to change the values of their respective data nodes without the standardized approval process; and
enabling the one or more business process objects to collect the changed values of the data nodes.
